(19) United States
(12) Patent Application Publication
(10) Pub. No.: US 2021/0073506 A1
(43) Pub. Date: Mar. 11, 2021

(54) TOUCH OBJECT OPERATING METHOD AND SCREEN UNLOCK METHOD ABLE TO SIMULTANEOUSLY OBTAIN FINGERPRINT INFORMATION, AND ELECTRONIC DEVICES RESPECTIVELY PERFORMING THE METHODS

(71) Applicant: Shanghai Harvest Intelligence Technology Co., Ltd., Shanghai (CN)

(72) Inventor: Jiandong HUANG, Shanghai (CN)

(73) Assignee: Shanghai Harvest Intelligence Technology Co., Ltd., Shanghai (CN)

(21) Appl. No.: 17/099,544

(22) Filed: Nov. 16, 2020

Related U.S. Application Data
(63) Continuation-in-part of application No. PCT/CN2019/087275, filed on May 16, 2019.
Application No. PCT/CN2019/087275 is a continuation-in-part of application No. PCT/CN2019/087276, filed on May 16, 2019.

(30) Foreign Application Priority Data
May 17, 2018 (CN) 201810475477.3
May 17, 2018 (CN) 201810475509.X

(51) Int. Cl. G06K 9/00; G09G 3/32; G06F 3/041; G06F 21/32

(52) U.S. Cl. CPC G06K 9/0004; G06K 9/00087; G09G 2354/00; G06F 3/0416; G06F 21/32; G09G 3/32

(57) ABSTRACT

A touch object operating method is to be implemented by an electronic device that includes a display unit and a sensor unit. The display unit is provided with a fingerprint recognition area, and displays at least one touch object in the fingerprint recognition area. The sensor unit is operable to obtain fingerprint information of a finger appearing in the fingerprint recognition area. The touch object operating method includes receiving an operation instruction made on the touch object by a finger of a user, and, simultaneously with receiving the operation instruction, obtaining fingerprint information of the finger of the user as input fingerprint information.

### CROSS-REFERENCE TO RELATED APPLICATION

This application is a continuation-in-part (CIP) application of PCT International Applications Nos. PCT/CN2019/087275 and PCT/CN2019/087276, both filed on May 16, 2019, which respectively claim priority of Chinese Patent Applications Nos. 201810475509.X and 201810475477.3, both filed on May 17, 2018.

### FIELD

The disclosure relates to touch control, and more particularly to a touch object operating method and a screen unlock method that are able to simultaneously obtain fingerprint information, and electronic devices that respectively perform the methods.

### BACKGROUND

With development of science and technology, touch display panels have been widely used in devices that require human-machine interfaces, such as industrial computers, tablet computers, smart phones, and so on. Use of these devices usually involves a large amount of user information, and therefore it is important to protect security of the user information. Among various information security protection approaches, an important one is fingerprint recognition encryption.

At present, an electronic device, when powered on, is generally unlocked by inputting gesture or fingerprint. Gesture unlocking includes comparing an input trajectory of a finger of a user to a predetermined movement trajectory, and unlocking the electronic device when the input trajectory matches the predetermined movement trajectory. The gesture unlocking approach does not identify the user's physiological characteristics, and thus has relatively higher security risk. Fingerprint unlocking includes comparing input fingerprint information of a finger of the user with predetermined fingerprint information, and unlocking the electronic device when the input fingerprint information matches the predetermined fingerprint information. Compared with the gesture unlocking approach, the fingerprint unlocking approach has dramatically reduced security risk.

A current display panel, such as a liquid crystal display (LCD), an active matrix organic light emitting diode (AMOLED) display, or a micro light emitting diode (micro-LED) display, uses thin film transistors (TFTs) to scan and drive a pixel array to realize display function. A TFT is a special type of semiconductor field effect transistor (FET), and has a semiconductor layer made of semiconductor materials that can be amorphous silicon, polysilicon, indium gallium zinc oxide (IGZO), or organic compound mixed with carbon nanomaterial, etc. Photodiodes can be made of such semiconductor materials, can be produced by equipment compatible with equipment for producing TFTs, and can be integrated with TFTs that are configurable to scan and drive the photodiodes. Therefore, in recent years, photodiodes have been produced using a process that is used to produce TFTs, and have been widely used in X-ray sensing flat panels, as described in Chinese Patent Nos. 103829959B and 102903721B.

Compared with image sensors made of conventional crystalline materials, photodiode array films made of the aforesaid semiconductor materials are more susceptible to interferences caused by ambient visible light and have lower signal-to-noise ratios (SNRs) since such semiconductor materials mainly absorb visible light to excite electrons across their band gaps. Therefore, such photodiode array films are mainly used in X-ray sensing flat panels since X-rays have short wavelengths and high collimation. An X-ray incident on a wavelength conversion material provided on an X-ray sensing flat panel is converted by the wavelength conversion material into visible light that has longer wavelengths and that travels in the X-ray sensing flat panel to arrive at a photodiode array film, thereby avoiding interferences caused by ambient visible light, as described in the aforesaid Chinese Patent Nos. 103829959B and 102903721B.

The aforesaid photodiode array film can be disposed in a display to make the display have photosensing function. However, because of factors such as thickness of the display and apertures of display pixels of the display, an image detected by the photodiode array film would be optically distorted under influence of, for example, diffraction, etc. In addition, optical display light beams and touch sensing light beams all propagate in the display having a multiple layer structure. Therefore, it is technically difficult to extract useful information from the touch sensing light beams with such a low SNR. The level of technical difficulty nearly reaches that of single photon imaging, and an undistorted image could only be reconstructed by calculation based on wave theories of light. In order to avoid such technical difficulty, an optical enhancement device is required. Alternatively, the photodiode array film is disposed at a lateral side of the display, and the undistorted image is reconstructed by using light that is non-vertically reflected to reach the lateral side, as described in Chinese Patent No. 101359369B. Although the aforesaid technologies can avoid the technical difficulty of low light imaging, using the optical enhancement device would increase the thickness of the display, and disposing the photodiode array film at the lateral side of the display prevents full screen experience.

In short, because of the structure of the current display, when the user is operating a touch object (e.g., a picture, a video, etc.) displayed by the display, the user has to additionally input fingerprint information if fingerprint authentication is required. This is cumbersome and brings negative experience to the user.

In addition, the current electronic device uses a sensor arranged outside a screen thereof to obtain the fingerprint information of the user. The user has to put the finger at a predetermined location on the electronic device outside the screen (e.g., a place where a home button is disposed for certain models of smart phones), so the sensor disposed below can obtain the fingerprint information of the user. The predetermined location is fixed, causing inconvenience for the user.

### SUMMARY

Therefore, an object of the disclosure is to provide a touch object operating method, a screen unlock method, and electronic devices that respectively perform the methods. Each method and the electronic device performing the method can alleviate at least one drawback of the prior art.

According to an aspect of the disclosure, the touch object operating method is to be implemented by an electronic device that includes a display unit and a sensor unit. The display unit is provided with a fingerprint recognition area, and displays at least one touch object in the fingerprint recognition area. The sensor unit is operable to obtain fingerprint information of a finger appearing in the fingerprint recognition area. The touch object operating method includes receiving an operation instruction made on the touch object by a finger of a user, and, simultaneously with receiving the operation instruction, obtaining fingerprint information of the finger of the user as input fingerprint information.

According to another aspect of the disclosure, the electronic device includes a display unit, a sensor unit and a processor. The display unit is provided with a fingerprint recognition area, and is to display at least one touch object in the fingerprint recognition area. The sensor unit is operable to obtain fingerprint information of a finger appearing in the fingerprint recognition area. The processor is configured to receive an operation instruction made on the touch object by a finger of a user, and control the sensor unit to, simultaneously with receiving the operation instruction, obtain fingerprint information of the finger of the user as input fingerprint information.

According to yet another aspect of the disclosure, the screen unlock method is to be implemented by an electronic device that includes a display unit and a sensor unit. The display unit is provided with a fingerprint recognition area. The sensor unit is disposed below the fingerprint recognition area, and is operable to obtain fingerprint information of a finger appearing in the fingerprint recognition area. The screen unlock method includes: receiving an input trajectory of a finger of a user in the fingerprint recognition area, and, simultaneously with receiving the input trajectory, obtaining fingerprint information of the finger of the user as input fingerprint information; when it is determined that the input trajectory matches a predetermined movement trajectory, determining whether the input fingerprint information matches predetermined fingerprint information; and when it is determined that the input fingerprint information matches the predetermined fingerprint information, unlocking a screen of the electronic device.

According to still another aspect of the disclosure, the electronic device includes a display unit, a sensor unit and a processor. The display unit is provided with a fingerprint recognition area. The sensor unit is disposed below the fingerprint recognition area, and is configured to receive an input trajectory of a finger of a user in the fingerprint recognition area, and to, simultaneously with receiving the input trajectory, obtain fingerprint information of the finger of the user as input fingerprint information. The processor is configured to execute a computer program that causes the processor to determine whether the input fingerprint information matches predetermined fingerprint information when it is determined that the input trajectory of the user matches a predetermined movement trajectory, and to unlock a screen of the electronic device when it is determined that the input fingerprint information matches the predetermined fingerprint information.

### BRIEF DESCRIPTION OF THE DRAWINGS

Other features and advantages of the disclosure will become apparent in the following detailed description of the embodiments with reference to the accompanying drawings, of which:

FIG. 1 is a diagram illustrating application of a photosensor array film;

FIG. 2 is a diagram illustrating display pixels of a display unit of an embodiment of an electronic device according to the disclosure;

FIG. 3 is a diagram illustrating change of an optical path of light emitted by a single display pixel in the embodiment of the electronic device;

FIG. 4 is a diagram illustrating change of the optical path of the light after an optical glue is applied in the embodiment of the electronic device;

FIG. 5 is a diagram illustrating change of the optical path of the light after the optical glue and an optical element are applied in the embodiment of the electronic device;

FIG. 6 is a diagram illustrating a detection area of a sensor unit of the embodiment of the electronic device related to the single display pixel;

FIG. 7 is a diagram illustrating the embodiment of the electronic device;

FIG. 8 is a flow chart illustrating a method performed by the embodiment of the electronic device to simultaneously obtain fingerprint information while receiving an operation instruction;

FIG. 9 is a diagram illustrating an implementation of a photosensor unit of the sensor unit;

FIG. 10 is a diagram illustrating another implementation of the photosensor unit;

FIG. 11 is a diagram illustrating yet another implementation of the photosensor unit;

FIG. 12 is a flow chart illustrating a method for fabricating the photosensor unit of FIG. 10;

FIG. 13 is a flow chart illustrating an embodiment of a touch object operating method according to the disclosure;

FIG. 14 is a block diagram illustrating an electronic device for implementing the embodiment of the touch object operating method;

FIGS. 15 to 17 are flowcharts further illustrating the embodiment of the touch object operating method; and

FIG. 18 is a flow chart illustrating an embodiment of a screen unlock method according to the disclosure.

### DETAILED DESCRIPTION

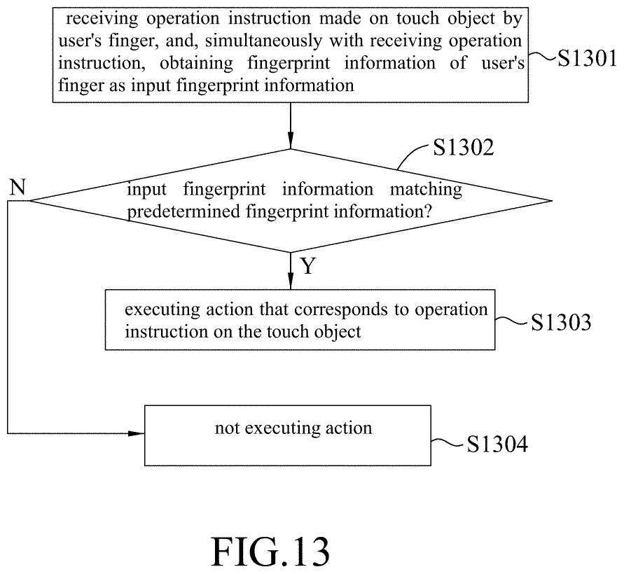

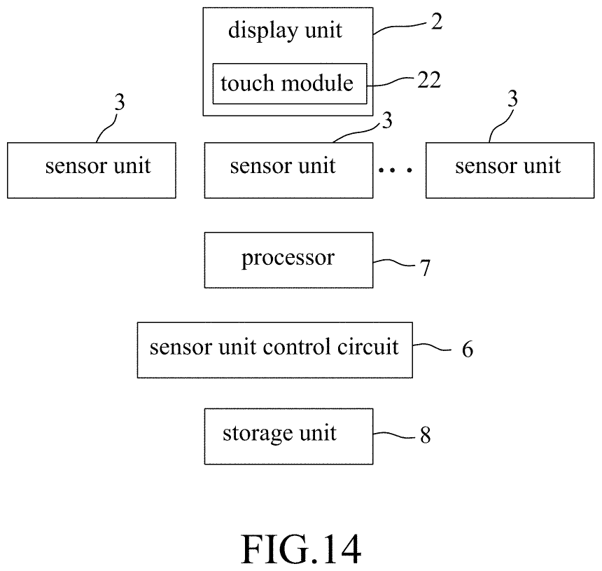

FIG. 13 illustrates an embodiment of a touch object operating method according to the disclosure. Referring to FIGS. 13 and 14, the touch object operating method is to be implemented by an electronic device that includes a display unit 2 and a sensor unit 3. The electronic device may be an electronic apparatus with a touch display, such as a mobile phone, a tablet computer, a personal digital assistant or other smart mobile apparatus, or may be a personal computer, a computer for industrial equipment or other electronic apparatus.

The display unit 2 is provided with a fingerprint recognition area, and displays at least one touch object in the fingerprint recognition area. The sensor unit 3 is disposed below the fingerprint recognition area, and is operable to obtain fingerprint information of a finger appearing in the fingerprint recognition area. The display unit 2 is a display that uses active matrix thin film transistors to achieve scan driving and data transmission, such as an active matrix organic light emitting diode (AMOLED) display, a liquid crystal display (LCD), a micro light emitting diode display, a quantum dot display, or an electronic ink display.

The touch object operating method includes step S1301.

In step S1301, the electronic device receives an operation instruction made on the touch object by a finger of a user, and, simultaneously, obtains fingerprint information of the finger of the user as input fingerprint information. The operation instruction is one of sliding, touching, pressing and clicking, and the touch object is one of a text, a picture, a video, an audio file, a folder, a document and an application icon.

In this embodiment, coverage of the sensor unit 3 is identical to a display area of the display unit 2 in size, so when the user operates the touch object displayed at any position on the display region, the sensor unit 3 can obtain the fingerprint information of the user. The operation instruction may be made by a single finger of the user, or may be made by multiple fingers of the user. When the operation instruction is made by multiple fingers of the user, pieces of fingerprint information of the multiple fingers of the user are obtained at the same time if the multiple fingers are all in the fingerprint recognition area during a time period when the operation instruction is made.

In other embodiments, the electronic device includes a plurality of the sensor units 3 which are disposed below the display unit 2, and the overall coverage of the sensor units 3 is identical to the display area in size. Compared with a sensor unit with a large sensing area, a sensor unit with a small sensing area is easier to produce, which helps save production costs.

In other embodiments, the fingerprint recognition area is smaller than the display area, for example, occupying half or a quarter of the display area. The fingerprint recognition area is rectangular, and is located in the center of the display area. In such case, the coverage of the sensor unit 3 is identical to the fingerprint recognition area in size (i.e., the sensor unit 3 and the fingerprint recognition area have the same dimensions). When the finger of the user is at a location outside the fingerprint recognition area, the fingerprint information of the user will not be obtained since the location outside the fingerprint recognition area is not covered by the sensor unit 3. When the user moves the touch object into the fingerprint recognition area by dragging or clicks on the touch object in the fingerprint recognition area, the sensor unit 3 will obtain the fingerprint information of the user. Since the sensor unit 3 only covers a portion of the display area, production costs can be effectively saved compared with the case where the sensor unit 3 covers the whole display area.

In some embodiments, the display unit 2 includes a touch module 22. The act of receiving the operation instruction made on the touch object by the finger of the user in step S1301 includes, by one of the sensor unit 3 and the touch module 22, receiving a sliding trajectory made on the touch object by the finger of the user, generating sliding trajectory information, and storing the sliding trajectory information. The touch module 22 may be a touch panel that is configured to detect a touch operation made thereon by the user. The touch operation includes sliding. Both of the sliding trajectory information and the fingerprint information may be obtained by the touch module 22. Alternatively, the sliding trajectory information may be obtained by the touch module 22, while the fingerprint information may be obtained by the sensor unit 3. In short, for an electronic device that is provided with the touch module 22, the option of obtaining the sliding trajectory information by either the sensor unit 3 or the touch module 22 can effectively promote diversity in application of the electronic device.

In some embodiments where the display unit 2 is one of an LCD and an electronic ink display, the electronic device further includes a backlight unit disposed below the sensor unit 3. The sensor unit 3 is disposed between the backlight unit and the display unit 2. The LCD is not self-luminous, so the backlight unit is required to be disposed below the sensor unit 3. The backlight unit may be an LCD backlight module or other self-luminous electronic component. In other embodiments where the display unit 2 is an AMOLED display, a backlight unit is not required since the AMOLED display is self-luminous. By virtue of the aforesaid varying schemes, production needs of different manufacturers can be effectively met, and diversity in application of the electronic device can be promoted.

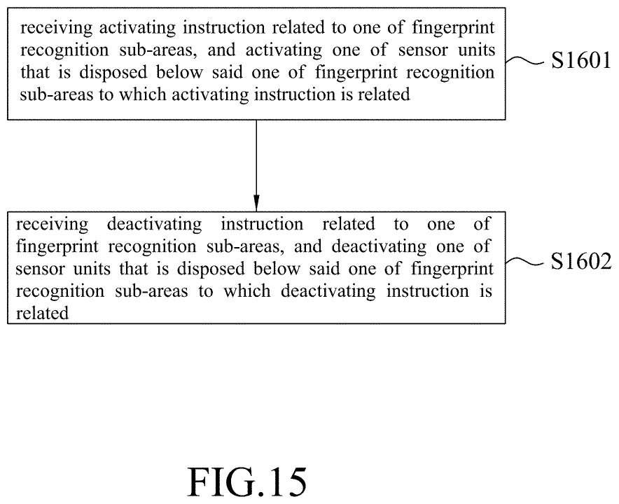

In some embodiments, the fingerprint recognition area includes a plurality of fingerprint recognition sub-areas. The electronic device includes a plurality of the sensor units 3 that are respectively disposed below the fingerprint recognition sub-areas, and further includes a processor 7 and a sensor unit control circuit 6. As shown in FIG. 15, the touch object operating method further includes steps S1601, S1602 related to control of the sensor units 3. In step S1601, when the processor 7 receives an activating instruction that is made by the user and that is related to one of the fingerprint recognition sub-areas, the sensor unit control circuit 6 activates one of the sensor units 3 that is disposed below said one of the fingerprint recognition sub-areas to which the activating instruction is related. In step S1602, when the processor 7 receives a deactivating instruction that is made by the user and that is related to one of the fingerprint recognition sub-areas, the sensor unit control circuit 6 deactivates one of the sensor units 3 that is disposed below said one of the fingerprint recognition sub-areas to which the deactivating instruction is related.

In an example where the fingerprint recognition area includes two fingerprint recognition sub-areas, the two fingerprint recognition sub-areas may be arranged in the display area in an up-to-down direction or a left-to-right direction (e.g., one located at the left side and one located at the right side), or may be arranged in the display area in other ways.

In application, both of the sensor units 3 respectively disposed below the two fingerprint recognition sub-areas are activated when the activating instruction made by user is received. Optionally, the two fingerprint recognition sub-areas cooperatively occupy the whole display area to ensure that when both of the sensor units 3 respectively disposed below the two fingerprint recognition sub-areas are activated, optical signals that pass through the display unit 2 can be absorbed by the sensor units 3 to obtain the fingerprint information of the user.

In other embodiments, the two fingerprint recognition sub-areas may cooperatively occupy, for example, two thirds or three quarters of the whole display area. In some embodiments, the user can set the electronic device based on his or her preferences to activate only the sensor unit 3 disposed below one of the fingerprint recognition sub-areas and not the sensor unit 3 disposed below the other one of the fingerprint recognition sub-areas. When the electronic device is not to be operated for an extended period, the user can set the electronic device to deactivate both of the sensor units 3 respectively disposed below the two fingerprint recognition sub-areas. In short, the sensor unit 3 disposed below each of the fingerprint recognition sub-areas can be activated or deactivated according to the user's preferences.

In some embodiments, the touch object operating method further includes a step of deciding, based on the input fingerprint information and predetermined fingerprint information, whether to execute an action that corresponds to the operation instruction made on the touch object.

To be specific, the touch object operating method further includes a step of presetting operation configuration information that indicates correspondences each between an operation instruction and a piece of predetermined fingerprint information. Each piece of the predetermined fingerprint information is preset by the user to be stored in advance, and corresponds to at least one operation instruction. For each operation instruction, whether to execute an action that corresponds to the operation instruction is decided based on one or more pieces of the predetermined fingerprint information. The operation configuration information may be stored in a storage unit 8 of the electronic device, such as a memory of a mobile phone or a hard disk of a computer, or may be stored in a storage unit of a server, in which case the electronic device would establish a communication connection with the server and obtain the operation configuration information from the server when the operation configuration information is needed, wherein the communication connection is one of a wired connection and a wireless connection.

The step of deciding whether to execute the action that corresponds to the operation instruction made on the touch object includes step S1302. In step S1302, the electronic device determines whether the input fingerprint information matches the predetermined fingerprint information. When it is determined that the input fingerprint information matches the predetermined fingerprint information, the flow proceeds to step S1303. Otherwise, the flow proceeds to step S1304. In step S1303, the action that corresponds to the operation instruction is executed on the touch object. In step S1304, the action that corresponds to the operation instruction is not executed. The operation instruction which is made on the touch object and received by the electronic device is the operation instruction which corresponds to the predetermined fingerprint information in the operation configuration information. Comparison of the input fingerprint information and the predetermined fingerprint information can be realized by fingerprint recognition algorithm. The fingerprint recognition algorithm may be stored in the storage unit 8 of the electronic device. When the sensor unit 3 obtains the input fingerprint information, the processor 7 of the electronic device uses the fingerprint recognition algorithm stored in the storage unit 8 to compare the input fingerprint information with the predetermined fingerprint information, which corresponds to the operation instruction received by the electronic device, to determine whether the input fingerprint information matches the predetermined fingerprint information. The fingerprint recognition algorithm includes steps such as preprocessing a fingerprint image, data feature extraction, feature matching, fingerprint recognition, etc., and can be implemented in various ways. These implementations are well developed, and have been applied in various encryption and decryption fields, so details thereof are omitted herein for the sake of brevity.

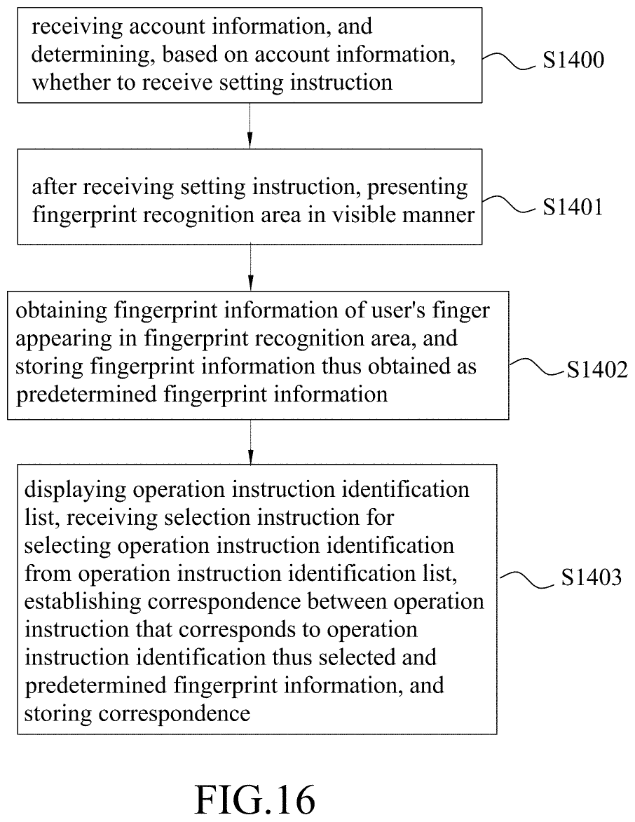

As shown in FIG. 16, in some embodiments, the step of presetting the operation configuration information includes sub-steps S1401-S1403.

In sub-step S1401, after receiving a setting instruction made by the user, the electronic device presents the fingerprint recognition area on the display unit 2 in a visible way. The setting instruction may be made by the user clicking a button in a setting field displayed by the display unit 2. After the electronic device receives the setting instruction, it presents the fingerprint recognition area in a visible manner, so the user can input fingerprint information at the fingerprint recognition area. In this embodiment, presenting the fingerprint recognition area in a visible manner includes increasing brightness of the fingerprint recognition area in comparison to the rest of the display area, or displaying an input prompt box in the fingerprint recognition area.

In some embodiments, the touch object operating method further includes, prior to sub-step S1401, a step S1400 of receiving account information inputted by the user and determining, based on the account information, whether to receive the setting instruction made by the user. The account information contains a user identification (ID) and a password. The setting instruction can be received when the user inputs the correct user ID and the correct password to log in to the user's account. Therefore, security of setup of the predetermined fingerprint information can be enhanced, and the electronic device can distinguish between different users and store corresponding predetermined fingerprint information for each user.

In sub-step S1402, the electronic device obtains fingerprint information of a finger of the user appearing in the fingerprint recognition area, and stores the fingerprint information thus obtained as the predetermined fingerprint information. When the tip of the finger of the user touches the fingerprint recognition area, the fingerprint information of the finger of the user is obtained, and is stored in a storage unit 8 as the predetermined fingerprint information. In one embodiment, the electronic device includes the storage unit 8, and sub-step S1402 includes determining whether the fingerprint information thus obtained has been stored in the storage unit 8, notifying the user that the fingerprint information has been stored if a result of the determination is affirmative, and storing the fingerprint information thus obtained in the storage unit 8 if the result of the determination is negative. This can effectively prevent the fingerprint information that corresponds to the same fingerprint from being stored repeatedly.

In sub-steps S1403, the electronic device displays an operation instruction identification list, receives a selection instruction made by the user to select an operation instruction identification from the operation instruction identification list, establishes the correspondence between an operation instruction that corresponds to the operation instruction identification thus selected and the predetermined fingerprint information, and stores the correspondence between the operation instruction and the predetermined fingerprint information. The operation instruction identification list contains at least one operation instruction identification, each of which corresponds to an operation instruction. The selection instruction may be made by the user clicking the operation instruction identification. Therefore, based on personal needs, the user can set up predetermined fingerprint information for operation instructions that correspond to important actions (e.g., payment, opening certain applications, opening confidential documents, etc.), and not for operation instructions that correspond to other less sensitive actions.

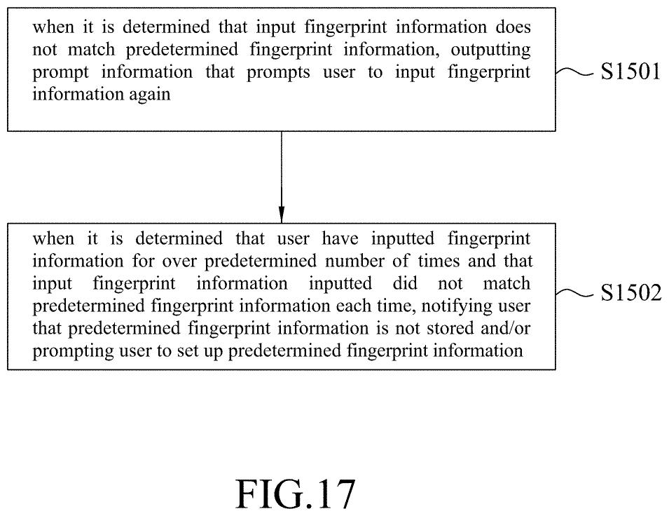

As shown in FIG. 17, in some embodiments, the touch object operating method further includes steps S1501, S1502. In step S1501, when it is determined that the input fingerprint information does not match the predetermined fingerprint information, the electronic device outputs prompt information that prompts the user to input fingerprint information again. In step S1502, when it is determined that the user has inputted fingerprint information for over a predetermined number of times and that the input fingerprint information inputted each time did not match the predetermined fingerprint information, the electronic device notifies the user that the predetermined fingerprint information is not stored, or prompts the user to set up the predetermined fingerprint information, or performs both the notifying and the prompting actions. The prompt information includes at least one of sound, image, light and video. It is determined that the input fingerprint information does not match the predetermined fingerprint information when one of a first case and a second case occurs. In the first case, fingerprint recognition fails, i.e., the predetermined fingerprint information is pre-stored in the storage unit 8 but the input fingerprint information is incomplete because the tip of the finger of the user was not in full contact with the display unit 2 during the procedure of obtaining the fingerprint information of the user, resulting in fingerprint recognition failure. In the second case, the predetermined fingerprint information is not stored in the storage unit 8.

For the first case, the electronic device outputs sound prompt information (e.g., via a speaker thereof) or image prompt information (e.g., via the display unit 2) when it determines that the input fingerprint information does not match the predetermined fingerprint information. The sound prompt information includes voice that prompts the user to input fingerprint information again. The image prompt information includes pop-up prompt information that prompts the user to input fingerprint information again. When the electronic device determines that the user has inputted fingerprint information for over the predetermined number of times and that the input fingerprint information inputted each time did not match the predetermined fingerprint information, the electronic device decides that the predetermined fingerprint information is not stored in the storage unit 8, i.e., the second case occurs.

For the second case, the electronic device may output image prompt information, e.g., a pop-up window, to notify the user that the predetermined fingerprint information is not stored, or may output video prompt information (e.g., via a speaker thereof and the display unit 2). The video prompt information contains a tutorial on how to set up the predetermined fingerprint information (i.e., the aforementioned sub-steps S1401-S1403 related to presetting the operation configuration information). The user can set up the predetermined fingerprint information by consulting the video prompt information. Of course, the prompt information may also be vibration, light, etc. In short, the prompt information is just a means to quickly notify the user that the input fingerprint information does not match the predetermined fingerprint information. The form of the prompt information can be adjusted according to requirements of different manufacturers.

In some embodiments, the electronic device includes a storage unit 8. The touch object operating method further includes a step of storing the input fingerprint information in the storage unit 8. It is not necessary for the input fingerprint information to be compared with the predetermined fingerprint information immediately after it is obtained by the sensor unit 3, and the input fingerprint information may be used later after a period of time has elapsed. Optionally, the storage unit 8 is a non-volatile memory device such as memory of a mobile phone, a hard disk, a flash drive, etc.

For example, on a shopping website, the products for sale are generally presented in the form of a list of pictures (i.e., touch objects). Conventionally, the user can add a product to a shopping cart by double clicking on the product picture or dragging the product picture to the shopping cart, and then pay for the product in the shopping cart through fingerprint recognition. Since fingerprint recognition in the payment process is independent of the operation in the product selection process, the conventional shopping procedure is rather complicated. By virtue of the touch object operating method of the disclosure, the electronic device can simultaneously obtain the fingerprint information of the user as the user is selecting the product. In an example where the operation instruction is pressing, when it is detected that force of the finger of the user pressing against the picture of the product exceeds a predetermined value, i.e., the operation instruction is being received, the electronic device simultaneously obtains the fingerprint information of the user as the input fingerprint information, compares the input fingerprint information with the predetermined fingerprint information, and completes the payment process when the input fingerprint information matches the predetermined fingerprint information. This simplifies the shopping procedure, and enhances user experience.

In addition, users generally do not want others to view videos or documents (i.e., touch objects) stored in their mobile phones or tablets without their permission. A conventional solution to preventing others from viewing these videos or documents is inconvenient, which compromises user experience. By virtue of the touch object operating method of the disclosure, when the user intends to open a video or a document through, for example, double clicking on, touching, or pressing the video or the document, the sensor unit 3 simultaneously obtains the input fingerprint information, and the video or the document is opened when the input fingerprint information matches the predetermined fingerprint information. This can effectively enhance security of accessing the video or the document while promoting user experience.

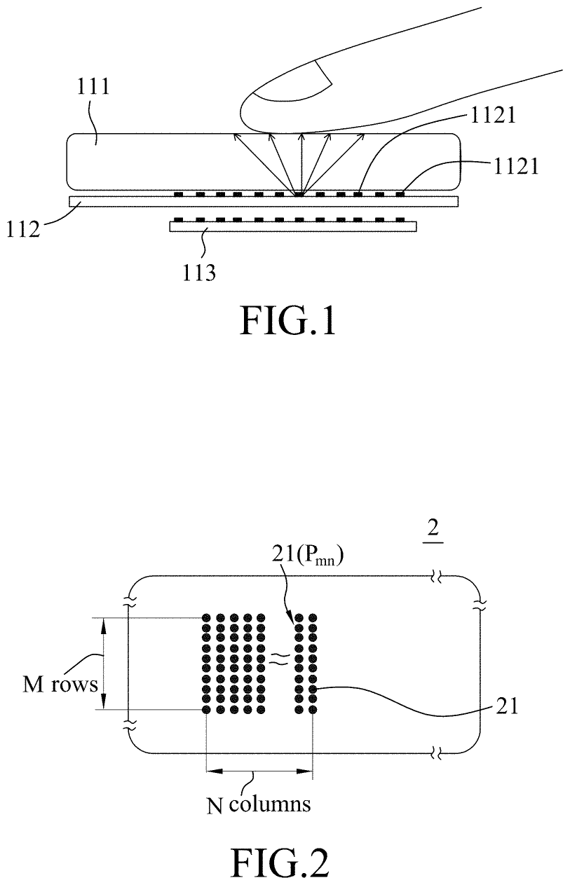

As shown in FIG. 1, a touch display device includes a cover glass, a touch screen and alight emitting diode (LED) display 112 that are sequentially arranged from top to bottom. The cover glass and the touch screen are simplified as an element 111 in FIG. 1. A photosensor array film 113 (i.e., a sensor unit) is disposed below the touch display device to detect and recognize physiological characteristics (e.g., fingerprint or palmprint) of a user. Taking fingerprint recognition as an example, the structure as shown in FIG. 1 has at least the following problems during fingerprint information obtaining process. First, various optical phenomena such as penetration, reflection, scattering, etc., occur for light that is emitted by some display pixels 1121 of the LED display 112 which are right below a finger of the user and that is incident on the finger, so effective reflected light that carries information related to a raised portion and a recessed portion of epidermis of the finger has very low luminance, and it is very difficult to distinguish between the raised portion and the recessed portion of the epidermis of the finger based on the effective reflected light. Second, because of materials and thicknesses of the cover glass, the touch screen, the LED display 112, etc., even if the luminance of the effective reflected light is high enough, the effective reflected light will be severely weakened (generally by more than 95%) after it has passed through the cover glass, the touch screen and the LED display 112 to arrive at the photosensor array film 113. In addition, the effective reflected light will be optically distorted after it has passed through apertures of the LED display 112. These adversely affect the acquisition of the fingerprint information. Third, each display pixel 1121 of the LED display 112 has low light emitting collimation, i.e., having wide light emitting angle, so light emitted by one display pixel 1121 and light emitted by neighboring display pixels 1121 interfere with each other easily, making the acquired fingerprint information inaccurate.

In order to solve the aforesaid problems, the disclosure provides an electronic device that is able to simultaneously obtain fingerprint information while receiving an operation instruction. The electronic device can be used to detect and recognize physiological characteristics such as fingerprint, palmprint, etc.

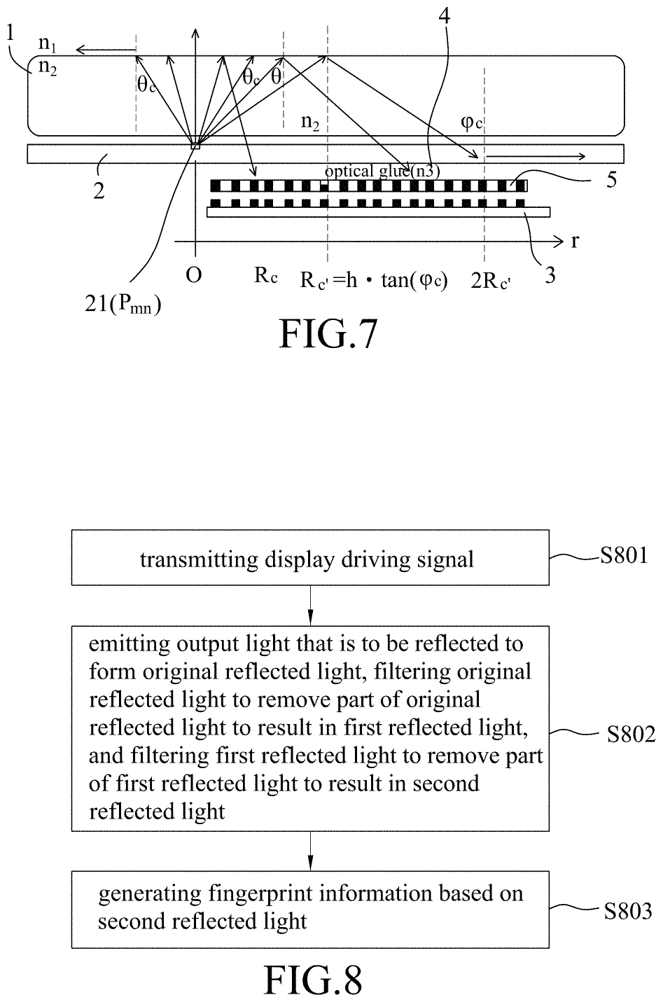

As shown in FIG. 7, the electronic device includes a cover glass, a touch screen, a display unit 2 (e.g., an LED display), an optical glue 4, an optical element 5 and a sensor unit 3 (e.g., a photosensor array film) that are sequentially arranged from top to bottom. The touch screen is attached to a lower surface of the cover glass. The optical glue 4 is attached to a lower surface of the display unit 2, and has a refractive index (n₃) smaller than that (n₂) of the cover glass. The display unit 2 includes a plurality of display pixels 21 (only one is labeled). For ease of description, the cover glass and the touch screen are simplified as an element 1 in FIG. 7, and change of an optical path occurring on a surface of the element 1 is simplified as change of an optical path occurring on a surface of the cover glass in the disclosure.

Since the photosensor array film is disposed below the display unit 2, light that is emitted by at least one of the display pixels 21 (e.g., a row or a column of the display pixels 21, or multiple ones of the display pixels 21 arranged to shine periodically or non-periodically) and that is reflected by the cover glass on which a finger of a user is disposed will eventually arrive at the photosensor array film. A part of the light that travels toward the raised portion of the epidermis of the finger is mostly absorbed by the raised portion, and a part of the light that travels toward the recessed portion of the epidermis of the finger is partially reflected by an air gap between the recessed portion and the cover glass, so the photo sensor array film can receive the reflected light with luminance that is greater at positions corresponding to the recessed portion than at positions corresponding to the raised portion, and can reconstruct fingerprint of the finger based on variations in luminance of the reflected light.

Referring to FIG. 2, the display unit 2 is an LED display that includes an LED pixel array, such as an organic light emitting diode (OLED) display, a micro-LED display, etc. The display unit 2 includes a number (M×N) of display pixels 21 that are arranged in a matrix with a number (M) of rows and a number (N) of columns. Change of an optical path of light emitted by a display pixel 21 which is in an m^{th} row and an n^{th} column and a position of which is denoted as Pₘₙ will be described in detail below. Change of an optical path of each of the other display pixels 21 can be inferred from the description below, and details thereof are omitted herein for the sake of brevity. Since thickness of the display unit 2 is less than one-tenth of that of the cover glass, and since a refractive index of the display unit 2 is close to that (n₂) of the cover glass, during the process of analyzing the change of the optical path, change of the reflected light occurring on a surface of the display unit 2 can be neglected to simplify the analysis.

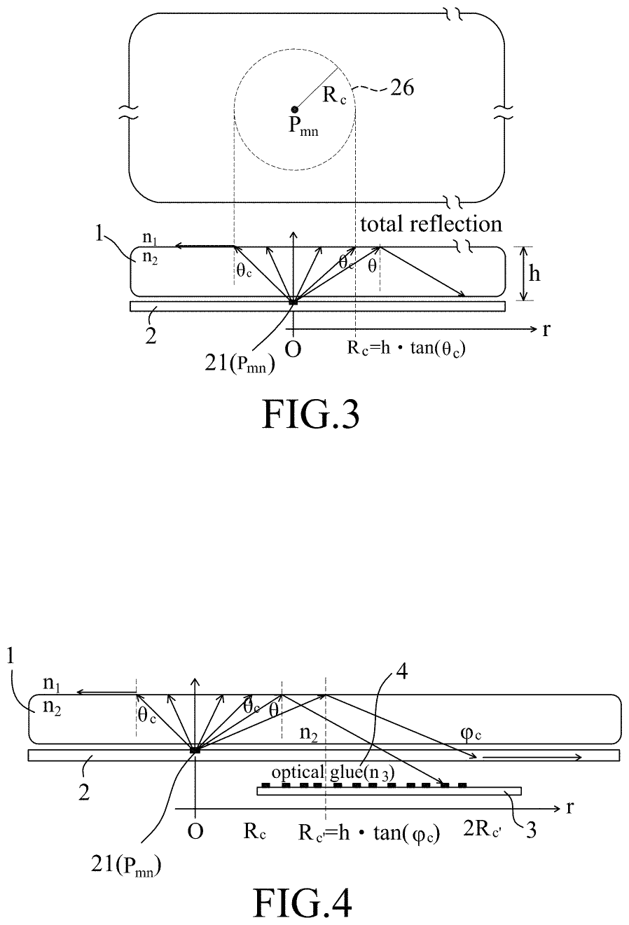

FIG. 3 illustrates change of an optical path of light emitted by a single display pixel 21 in an embodiment. A top view of the electronic device is depicted in the upper portion of FIG. 3, and a side view of the electronic device is depicted in the lower portion of FIG. 3.

The refractive index (n₂) of the cover glass is about 1.5. A refractive index (n₁) of air is about 1.0. The display pixel 21 at the position (Pₘₙ) emits output light upward with a wide angle of coverage. When an upper surface of the cover glass is not touched by the finger of the user, a part of the output light incident on the upper surface of the cover glass at an angle of incidence (θ) greater than a critical angle (θ_{c}=sin⁻¹ (n₁/n₂)) will be totally internally reflected in the cover glass. That is, the critical angle (θ_{c}) is a smallest angle of incidence of the output light on the upper surface of the cover glass that yields total internal reflection in the cover glass, and the part of the output light is incident on the upper surface of the cover glass at positions outside a first dashed circle 26 with a center at the position (Pₘₙ) and a radius of R_{c}. When the finger touches the upper surface of the cover glass, the raised portion of the epidermis of the finger will alter the aforesaid condition of total internal reflection, but the recessed portion of the epidermis of the finger will not alter the aforesaid condition of total internal reflection because of the air gap between the recessed portion and the cover glass. Therefore, those light beams of the part of the output light incident on the upper surface of the cover glass at positions corresponding to the raised portion will not be totally internally reflected in the cover glass, and those at positions corresponding to the recessed portion will be totally internally reflected in the cover glass, and the reflected light travelling toward the sensor unit 3 (see FIG. 7) (e.g., the photosensor array film) has lower luminance at positions corresponding to the raised portion and higher luminance at positions corresponding to the recessed portion.

In short, compared to a part of the output light incident on the upper surface of the cover glass at positions inside the first dashed circle 26 of FIG. 3, the part of the output light incident on the upper surface of the cover glass at positions outside the first dashed circle 26 of FIG. 3 can be used to better detect the recessed portion of the epidermis of the finger which forms the air gap with the cover glass therebetween. Therefore, R_{c} plays an important role in obtaining a highly sensitive reflection area for detecting fingerprint. Assuming that the thickness of the cover glass is h, R_{c}=h·tan(θ_{c}).

Although those light beams of the part of the output light incident on the upper surface of the cover glass at positions corresponding to the recessed portion of the epidermis of the finger and at the angle of incidence (θ) greater than the critical angle (θ_{c}) can be accurately and totally internally reflected in the cover glass, as the angle of incidence (θ) increases, a distance traveled by the reflected light that is formed by the output light being reflected by the upper surface of the cover glass (referred to as original reflected light hereinafter) increases as well, and useful information contained in the original reflected light attenuates more severely, and may even be determined as noise, when it arrives at the photosensor array film. Therefore, it is also necessary to define a maximum detection area for detecting useful information when the display pixel 21 at the position (Pₘₙ) is exemplarily used to emit the output light.

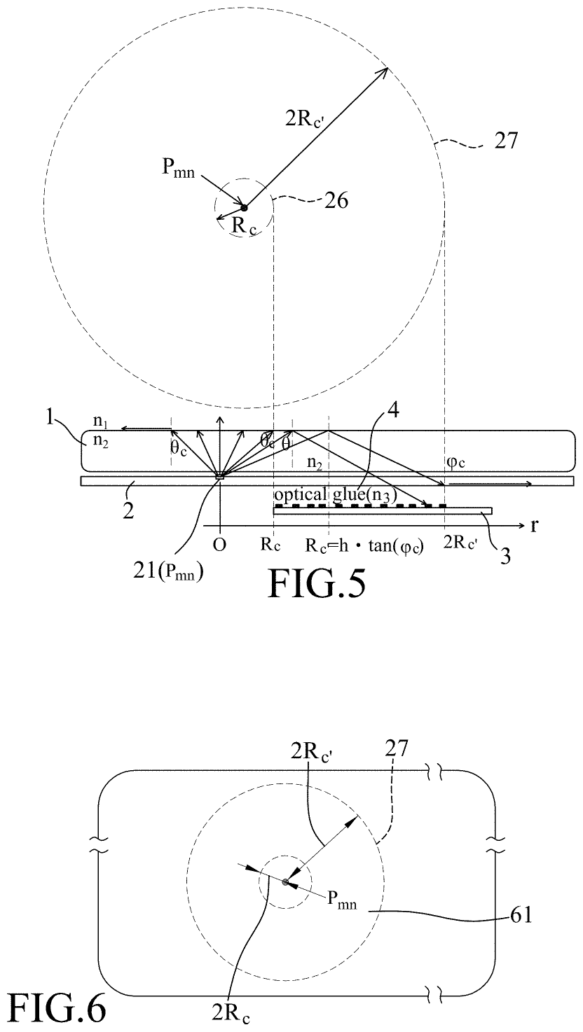

Referring to FIGS. 4 and 5, since the refractive index (n₃) of the optical glue 4 is less than the refractive index (n₂) of the cover glass, a part of the original reflected light incident on a surface of the optical glue 4 at an angle of incidence greater than internally reflected. That is, the critical angle ((Pc) is a smallest angle of incidence of the original reflected light on the surface of the optical glue 4 that yields total internal reflection in the display unit 2, and the part of the original reflected light is incident on the surface of the optical glue 4 at positions outside a second dashed circle 27 with a center at the position (Pₘₙ) and a radius of 2·R_{c′}, where R_{c′}≅h·tan (φ_{c}). Compared to a part of the original reflected light incident on the surface of the optical glue 4 at positions inside the second dashed circle 27, the part of the original reflected light incident on the surface of the optical glue 4 at positions outside the second dashed circle 27 travels a longer distance, and not so much useful information for fingerprint recognition is contained therein. Therefore, the part of the original reflected light incident on the surface of the optical glue 4 at positions outside the second dashed circle 27 will be removed (i.e., prevented from arriving at the sensor unit 3) by the optical glue 4 through total internal reflection in the display unit 2.

The light that is emitted by the display pixel 21 at the position (Pₘₙ), that is incident on the upper surface of the cover glass at positions outside the first dashed circle 26 and that is incident on the surface of the optical glue 4 at positions inside the second dashed circle 27 contains highly accurate useful information. Therefore, as shown in FIG. 6, a detection area on the photosensor array film for sensitively and effectively detecting fingerprint is a ring area 61 that is to receive the light, and that has a center at the position (Pₘₙ), an inner radius of 2·R_{c} and an outer radius of 2·R_{c′}.

As described above, the optical glue 4 can filter the original reflected light to remove the part of the original reflected light incident on the surface of the optical glue 4 at positions outside the second dashed circle 27 to result in a first reflected light that is allowed to travel toward the photosensor array film. That is, the part of the original reflected light incident on the surface of the optical glue 4 is totally internally reflected in the display unit 2, and will not enter the photosensor array film to affect acquisition of the fingerprint information. In addition, the optical element 5 (see FIG. 7) disposed on the photosensor array film is used to remove a part of the first reflected light incident on a surface of the optical element 5 at an angle of incidence greater than the critical angle (θ_{c}). The part of the first reflected light is incident on the upper surface of the cover glass at positions inside the first dashed circle 26. In this embodiment, the optical element 5 is one of a light-shielding optical element, a phase-change optical element and a combination thereof. The light-shielding optical element includes one of a pinhole array with regularly arranged pinholes and a pinhole array with irregularly arranged pinholes. The phase-change optical element includes one of a photonic crystal structure, a microlens array structure and a diffuse scattering structure. Each of the photonic crystal structure and the micro lens array structure has a refractive index that changes regularly. The diffuse scattering structure has a refractive index that changes irregularly.

Optionally, each pinhole is circular or rectangular. The optical element 5 is designed by using compressive sampling of coded apertures. Taking fingerprint recognition as an example, only bright and dark gray levels are required for fingerprint recognition. In this embodiment, the light incident on the upper surface of the cover glass at the angle of incidence (θ) smaller than the critical angle (θ_{c}) should be removed. Through spatial filtering design, coded apertures of the optical element 5 are designed to have light guiding function, such that the light which is incident on the upper surface of the cover glass at the angle of incidence (θ) greater than the critical angle (θ_{c}) and which contains highly distinguishable bright and dark information can pass through the optical element 5 and enter the photosensor array film at an angle of incidence smaller than a predetermined angle (e.g., as perpendicular as possible). The compressive sampling of coded apertures is disclosed in “Coded apertures: past, present, and future application and design” by Stephen R. Gottesman, Proceeding of SPIE, vol. 6714, 2007. This article uses a simple one-dimensional model to illustrate that coded apertures can be widely used in designing a thin optical element which requires high discrimination and wide viewing angle. In short, through the compressive sampling of coded apertures, the optical element 5 can be designed based on predetermined parameter requirements (i.e., the light incident on the upper surface of the cover glass at the angle of incidence (θ) smaller than the critical angle (θ_{c}) should be removed). Specific steps of the compressive sampling of coded apertures are known in the art, and details thereof are omitted herein for the sake of brevity.

In other embodiments, the optical element 5 is designed by using digital holography. Through the digital holography (also known as computer-generated holography), the optical element 5 can be designed based on the predetermined parameter requirements (i.e., the light incident on the upper surface of the cover glass at the angle of incidence (θ) smaller than the critical angle (θ_{c}) should be removed). Specific steps of the digital holography are disclosed in “Synthesis of digital holograms by direct binary search” by MA Seldowitz, J P Allebach, and D W Sweeney, Appl. Opt. 26, 2788-2798 (1987). This article proposes that a computer can be used to design a digital holography optical element based on a specific algorithm to obtain highly distinguishable output images.

In this embodiment, the electronic device includes a cover glass, a touch screen, a display unit 2, an optical glue 4, an optical element 5 and a sensor unit 3 that are sequentially arranged from top to bottom (see FIG. 7). The touch screen is attached to a lower surface of the cover glass. The optical glue 4 is attached to a lower surface of the display unit 2, and has a refractive index (n₃) smaller than that (n₂) of the cover glass. The display unit 2 includes a plurality of display pixels 21. The electronic device further includes a processor 7 (see FIG. 14). As shown in FIG. 8, a method including the following steps (S801, S803, S805) is performed such that the processor 7 can control the sensor unit 3 to obtain fingerprint information of a finger of a user simultaneously with receiving, by one of the sensor unit 3 or a touch module 22 (see FIG. 14), an operation instruction made on a touch object by the finger of the user.

In step S801, the processor 7 transmits a display driving signal to the display unit 2 when the touch screen detects touch of the finger of the user. Taking fingerprint recognition as an example, the touch screen transmits a touch signal to the processor 7 for triggering transmission of the display driving signal when it detects that the upper surface of the cover glass is touched by the finger of the user. In application, when the user is to click or press the touch object displayed on a screen of the electronic device, the finger of the user will touch the cover glass to trigger the transmission of the touch signal.

In step S803, at least one of the display pixels 21 (only one is depicted in FIG. 7) emits an output light when receiving the display driving signal from the processor 7. The output light is partially reflected on an upper surface of the cover glass to form an original reflected light. The optical glue 4 filters the original reflected light to remove a part of the original reflected light incident on a surface of the optical glue 4 at an angle of incidence greater than a first critical angle (φ_{c}) to result in a first reflected light which is allowed to enter the optical element 5. The optical element 5 filters the first reflected light to remove a part of the first reflected light incident on a surface of the optical element 5 at an angle of incidence smaller than a second critical angle (θ_{c}) to result in a second reflected light, and makes the second reflected light enter the sensor unit 3 at an angle of incidence smaller than a predetermined angle.

The display unit 2 and the cover glass are transparent, so a part of the output light is reflected on the upper surface of the cover glass to form the original reflected light, and the other part of the output light penetrates the upper surface of the cover glass to go into the air. Only the original reflected light can enter the sensor unit 3 to be converted into fingerprint information. Step S803 is executed to filter the original reflected light.

The first critical angle (φ_{c}) is a smallest angle of incidence of the original reflected light on the surface of the optical glue 4 that yields total internal reflection in the display unit 2. In short, the optical glue 4 having the refractive index (n₃) smaller than that (n₂) of the cover glass is applied to remove a part of the original reflected light travelling a long distance (i.e., apart of the original reflected light incident on the surface of the optical glue 4 at positions outside the second dashed circle 27 (see FIG. 5)).

The second critical angle (θ_{c}) is a smallest angle of incidence of the output light on the upper surface of the cover glass that yields total reflection in the cover glass. In short, the optical element 5 is applied to remove the part of the first reflected light which corresponds to the part of the output light incident on the upper surface of the cover glass at positions inside the first dashed circle 26, and to make unremoved part of the first reflected light (i.e., the second reflected light) enter the sensor unit 3 as perpendicularly as possible so as to increase luminous flux for better acquisition of fingerprint information.

In step S805, the sensor unit 3 receives the second reflected light, generates the fingerprint information of the user based on the second reflected light, and provides the fingerprint information of the user to the processor 7 as input fingerprint information. The second reflected lights respectively related to the display pixels 21 are superimposed to reconstruct complete fingerprint information. In other implementations, the fingerprint information may be replaced with other physiological feature information, such as palmprint information.

In some embodiments, the display unit 2 includes a number (M×N) of display pixels 21 that are arranged in a matrix with a number (M) of rows and a number (N) of columns (see FIG. 2). Based on a predetermined timing signal, the processor 7 drives at least one of the display pixels 21 at a time to emit the output light, so as to format least one light spot on the upper surface of the cover glass at a time and to scan the finger of the user to form the original reflected light. Based on the predetermined timing signal, the processor 7 may drive the display pixels 21 to emit the output light column by column, row by row, in a periodic and discrete manner (e.g., first, the display pixels at positions (P₁₁, P₁₃, P₁₅) emit the output light; second, the display pixels at positions (P₂₁, P₂₃, P₂₅) emit the output light; third, the display pixels at positions (P₃₁, P₃₃, P₃₅) emit the output light; and so on and so forth), or in a non-periodic manner. In short, the manner in which the processor 7 drives the display pixels 21 to emit the output light can be decided based on application requirements.

In some embodiments, the sensor unit 3 provides a number (P×Q) of pixel sensing areas, and includes a number (P×Q) of pixel sensing structures respectively disposed in the pixel sensing areas. Each of the pixel sensing structures includes a pixel film circuit that includes at least one thin film transistor, and a photosensor unit that includes one of a photosensitive diode and a photosensitive transistor. The photosensor unit can be implemented in the following ways.

First Implementation

The photosensor unit of each of the pixel sensing structures includes the photosensitive diode. When the sensor unit 3 is implemented by the photosensor array film, the photosensor array film is a photosensitive diode array that provides a photosensitive diode sensing area. A conventional LCD or a conventional OLED display uses thin film transistors (TFTs) to drive and scan the display pixels 21 to realize display function of the display unit 2. A TFT is a special type of semiconductor field effect transistor (FET), and has a semiconductor layer made of semiconductor materials that can be amorphous silicon, polysilicon, indium gallium zinc oxide (IGZO), or organic compound mixed with carbon nanomaterial, etc. Photosensitive diodes can be made of such semiconductor materials, and can be produced by equipment compatible with equipment for producing TFTs. Therefore, in recent years, photosensitive diodes have been produced using a process that is used to produce TFTs. Structures of conventional photosensitive diodes are described in U.S. Pat. No. 6,943,070B2 and Chinese Patent No. 204808361U. The production process of the photosensor array film is different from the production process of the TFTs of the display unit 2 in that a pixel aperture area of the display unit 2 is changed to alight sensing area of the photosensor array film. The TFTs can be prepared by using a thin glass as a substrate or using a high temperature resistant plastic material as a substrate, as described in U.S. Pat. No. 6,943,070B2.

Conventional photosensor array films are more susceptible to interferences caused by ambient visible light and have lower signal-to-noise ratios (SNRs) since such semiconductor materials mainly absorb visible light to excite electrons across their band gaps.

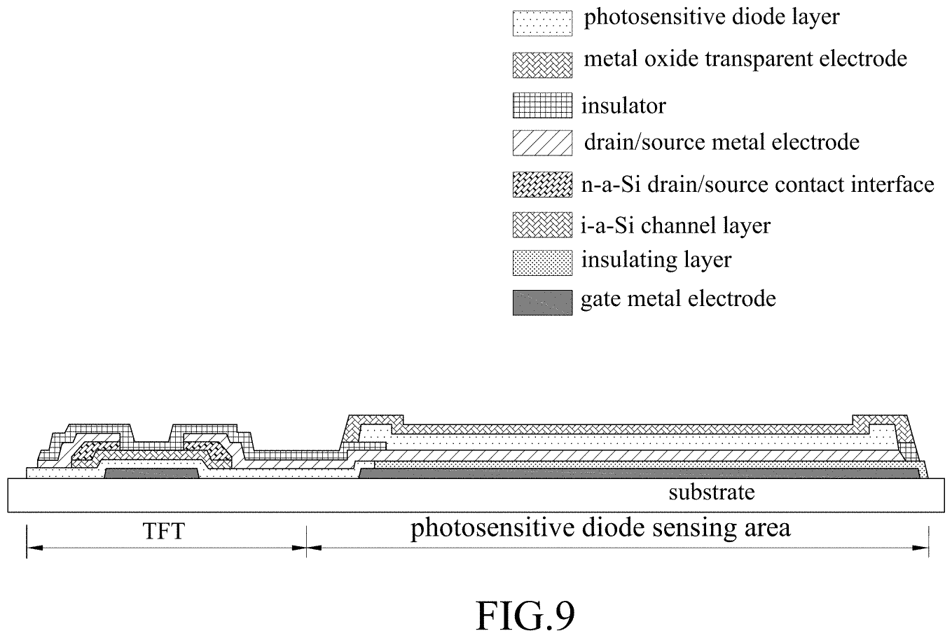

A conventional photosensor array film disposed below a display unit is affected easily by factors such as reflection or refraction of ambient light or visible light emitted by display pixels of the display unit, causing optical interferences and seriously affecting a signal-to-noise ratio (SNR) of the conventional photosensor array film. In order to enhance the SNR, as shown in FIG. 9, the photosensitive diode is improved in the disclosure, so the photosensor array film using the improved photosensitive diode can detect and recognize infrared light reflected by a user's body part. A specific structure of the improved photosensitive diode is as follows.

The photosensitive diode includes at least one stack structure each formed by a p-type semiconductor layer, an i-type semiconductor layer and an n-type semiconductor layer that are sequentially arranged from top to bottom. The i-type semiconductor layer of each of the at least one stack structure is one of a microcrystalline silicon structure and an amorphous germanium silicide structure. The microcrystalline silicon structure is a semiconductor layer formed by chemical vapor deposition of silane and hydrogen. Crystallinity of the microcrystalline silicon structure is greater than 40%, and a band gap of the microcrystalline silicon structure is less than 1.7 eV. The amorphous germanium silicide structure is an amorphous semiconductor layer formed by chemical vapor deposition of silane, hydrogen and germane, and has a band gap of less than 1.7 eV.

A band gap refers to a band gap width (in electron volts (eV)). Energies of electrons in a solid cannot be continuously numeralized, but are in some discontinuous energy bands. Existence of free electrons is required for electric conductivity. An energy band in which the free electrons exist is called a conduction band (which can conduct electricity). If it is desirable to permit bound electrons to become free electrons, they must obtain enough energy to jump from a valence band to the conduction band. A minimum value of the energy is the band gap. The band gap is an important characteristic parameter of a semiconductor, and a magnitude thereof is mainly determined by an energy band structure of the semiconductor, that is, it is related to a crystal structure, bonding properties of atoms, and the like.

At room temperature (300 K), the band gap of germanium is about 0.66 eV. Silane contains germanium elements. When the germanium elements are doped, the band gap of the i-type semiconductor layer is decreased. When the band gap of less than 1.7 eV is satisfied, the i-type semiconductor layer can receive optical signals in a wavelength range of from visible light to infrared light (or near-infrared light). An operating wavelength range of a photosensitive diode containing an amorphous or microcrystalline germanium silicide structure can be extended to a wavelength range of from 600 nm to 2000 nm by adjusting a GeH4 concentration for chemical vapor deposition.

Second Implementation

On the basis of the first implementation, in order to improve a quantum efficiency for photoelectric conversion, the amorphous silicon photosensitive diode can also be formed by stacking double- or multi-junction p-type/i-type/n-type structures. The p-type/i-type/n-type structure of the first junction layer of the photosensitive diode is still an amorphous silicon structure, and the p-type/i-type/n-type structure of the second junction layer or the other junction layers of the photosensitive diode may be a microcrystalline structure or a polycrystalline structure, or may be doped with a compound material that may extend a photosensitive wavelength range. In short, a plurality of sets of the p-type/i-type/n-type structures can be stacked on each other to assemble a photosensitive diode. For each of the p-type/i-type/n-type structures, the structure of the photosensitive diode described in the first implementation is used.

Third Implementation

On the basis of the first implementation or the second implementation, for each of the p-type/i-type/n-type structures, the p-type semiconductor layer included therein may be a multilayer structure of more than two layers. For example, the p-type semiconductor layer is a three-layered structure, and includes a first p-type semiconductor layer (a p1 layer), a second p-type semiconductor layer (a p2 layer), and a third p-type semiconductor layer (a p3 layer) from top to bottom. Among them, the p1 layer can adopt an amorphous structure and is heavily doped with boron (a boron concentration is more than twice that for a standard process). The p2 and p3 layers adopt a microcrystalline structure, and are normally doped with boron (doped in a concentration for the standard process). Absorption of light is reduced by the p2 layer and the p3 layer having decreased thicknesses, so that the light may enter the i layer as much as possible and is absorbed by the i layer, thereby increasing a photoelectric conversion rate. In addition, the p2 layer and the p3 layer are doped with boron in a normal concentration. It is possible to effectively avoid deterioration of a built-in potential due to heavy doping of the p1 layer. When the p-type semiconductor layer is a multilayer structure having different layer numbers, it is similar to that described herein, and will not be described again.

Similarly, the n-type semiconductor layer may also be a multilayer structure of more than two layers. For example, the n-type semiconductor layer has a three-layered structure, and includes a first n-type semiconductor layer (an n1 layer), a second n-type semiconductor layer (an n2 layer), and a third n-type semiconductor layer (an n3 layer) from top to bottom. Among them, the n3 layer can adopt an amorphous structure and be heavily doped with phosphorus (a phosphorus concentration is more than twice that for a standard process), while the n1 and n2 layers can adopt a microcrystalline structure and be normally doped with phosphorus (according to a standard production process). Absorption of light is reduced by the n1 layer and the n2 layer having decreased thicknesses, so that the light may enter the i layer as much as possible and be absorbed by the i layer, thereby increasing the photoelectric conversion rate. In addition, the n1 layer and the n2 layer are doped with phosphorus in a normal concentration. It is possible to effectively avoid deterioration of a built-in potential due to heavy doping of the n3 layer. When the n-type semiconductor layer is a multilayer structure having different layer numbers, it is similar to that described herein, and will not be described again.

Fourth Implementation

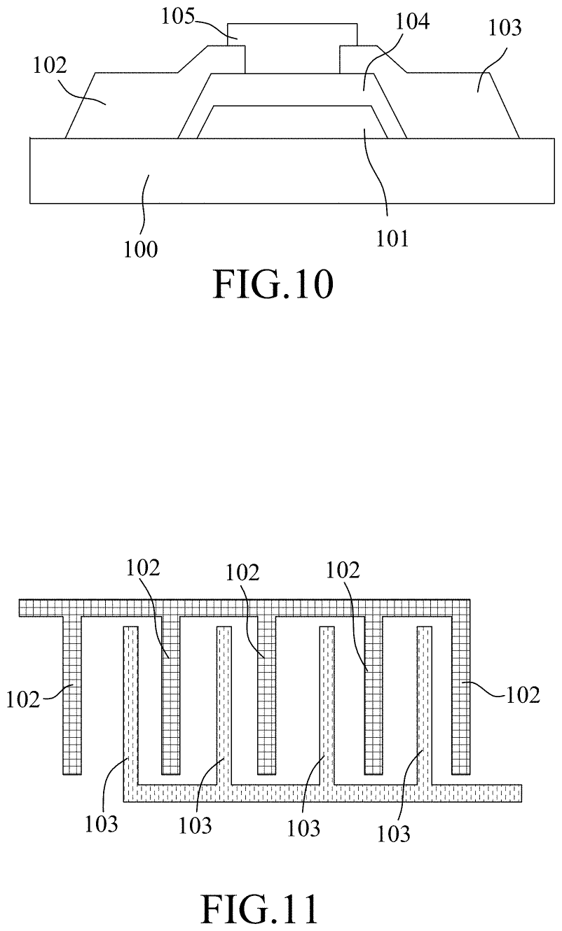

The photosensor unit of each of the pixel sensing structures includes the photosensitive transistor. The photosensor array film is a photosensitive transistor array that provides a photosensitive transistor sensing area. The photosensor unit includes a photosensitive TFT disposed in the photosensitive transistor sensing area. As shown in FIG. 10, the photosensitive TFT includes a gate 101, a source 102, a drain 103, an insulating layer 104 and a light-absorbing semiconductor layer 105. The photosensitive TFT has a structure in which the gate 101, the insulating layer 104 and the source 102 are sequentially arranged from bottom to top in a longitudinal direction, the drain 103 and the source 102 are disposed coplanarly in a transverse direction, the insulating layer 104 covers the gate 101 so that the gate 101 is not in contact with the source 102 and the drain 103, the source 102 and the drain 103 are spaced apart to form a photosensitive leakage current channel therebetween, and the light-absorbing semiconductor layer 105 is disposed in the photosensitive leakage current channel (hereinafter also referred to as an inverted structure).

Generally, when the TFT is operated to an off state by a gate voltage, no current flows between the source and the drain. However, when the TFT is irradiated by a light source, electron-hole pairs are excited in the semiconductor by light energy. The field effect of the TFT separates the electron-hole pairs, which in turn causes the TFT to generate photosensitive leakage current. Such a photosensitive leakage current characteristic allows the TFT to be applied to a light detection technique or the like. Compared to a device adopting a conventional TFT as a photosensitive TFT, the electronic device of the disclosure adopts a TFT with the inverted structure, i.e., the light-absorbing semiconductor layer 105 is disposed at the top, which greatly increases photoelectron excitation and improves the photoelectric conversion efficiency.

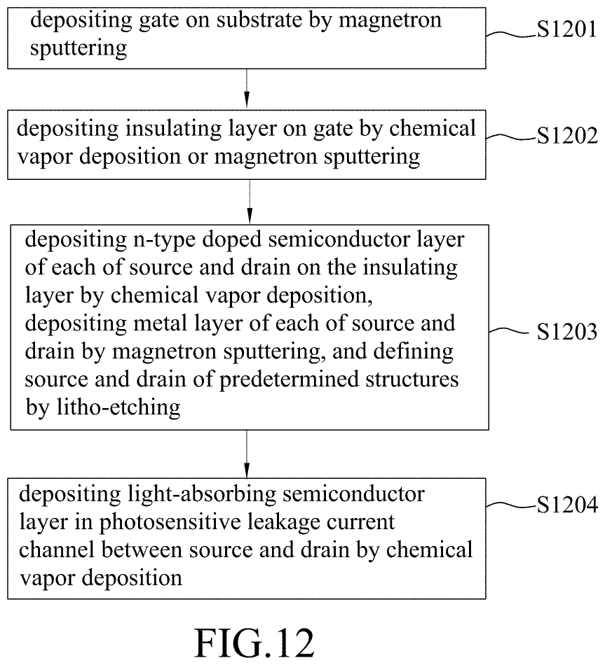

FIG. 12 is a flow chart illustrating a method for fabricating a photosensor unit used in an implementation of the disclosure. The method is used to prepare the photosensitive TFT (i.e., the photosensor unit) of the fourth implementation, and specifically includes steps S1201-S1204.

In step S1201, the gate 101 is deposited on the substrate 100 of the photosensitive TFT by magnetron sputtering. The substrate 100 of the photosensitive TFT may be a rigid plate or a flexible material (e.g., polyimide).

In step S1202, the insulating layer 104 is deposited on the gate 101 by chemical vapor deposition or magnetron sputtering.

In step S1203, an n-type doped semiconductor layer of each of the source 102 and the drain 103 is deposited on the insulating layer 104 by chemical vapor deposition, a metal layer of each of the source 102 and the drain 103 is deposited by magnetron sputtering, and the source 102 and the drain 103 of predetermined structures are defined by litho-etching, such that the source 102 and the drain 103 are laterally coplanar and spaced apart and such that the photosensitive leakage current channel is formed between the source 102 and the drain 103.

In step S1204, the light-absorbing semiconductor layer 105 is deposited in the photosensitive leakage current channel by chemical vapor deposition.

Fifth Implementation

In well-known FET structures, the TFT as a switch for scan driving and data transmission does not need to be specially designed for a structure for collecting photocurrent between the source and the drain. However, for application of the FET to detection of the photosensitive leakage current, if a drift path driven by an electric field is too long after electron-hole pairs excited by light are separated by a field effect, it is very likely that the photoelectrons will recombine with the holes before they reach the electrodes smoothly, or will be captured by a dangling bond defect of the light-absorbing semiconductor layer, so they cannot effectively contribute to a photocurrent output for photo-detection. In order to improve the effect of a channel length between the source and the drain on the photosensitive leakage current so as to increase an area of the light-absorbing semiconductor without deteriorating the photoelectric conversion efficiency, the source 102 and the drain 103 of the fourth implementation are further modified in this implementation. New structures for the source and the drain are provided.

As shown in FIG. 11, the numbers of the sources 102 and the drains 103 are plural. The sources 102 are arranged in parallel and are connected to each other. The drains 103 are arranged in parallel and are connected to each other. The sources 102 and the drains 103 are spaced apart to form photosensitive leakage current channels each between one of the sources 102 and an adjacent one of the drains 103. Specifically, a first gap between any two adjacent ones of the sources 102 is provided with one of the drains 103, a second gap between any two adjacent ones of the drains 103 is provided with one of the sources 102, and the sources 102 are interleaved with and spaced apart from the drains 103. A distance between each of the sources 102 and an adjacent one of the drains 103 is less than an electron drift distance, which is a distance at which an electron can survive under a field effect. In this way, in the photosensitive TFT, the sources 102 are arranged in parallel and connected to each other, and the drains 103 are also arranged in parallel and connected to each other, which can effectively reduce probability of recombination of the photo-excited electrons and holes. The successful probability of collecting photoelectrons by the electrodes under influence of the field effect is improved, and the photosensitivity of the photosensitive TFT is maximized.

In the process for preparing the photosensitive TFT (i.e., the photosensor unit) of the fifth implementation, the general steps thereof are similar to those for preparing the photosensitive TFT of the fourth implementation except for the following differences. In preparation of the sources 102 and the drains 103, source sets and drain sets are defined by litho-etching. Each of the source sets includes a plurality of the sources 102, and the sources 102 in the source set are arranged in parallel and connected to each other. Each of the drain sets includes a plurality of the drains 103, and the drains 103 in the drain set are arranged in parallel and connected to each other. A first gap is formed between any two adjacent ones of the sources 102 and is provided with one of the drains 103. A second gap is formed between any two adjacent ones of the drains 103 and is provided with one of the sources 102. The sources 102 are interleaved with and spaced apart from the drains 103.

In some embodiments, the photosensor array film receives a detection trigger signal, enters a light detection state, and receives light reflected by a detection part (e.g., a finger, an eyeball, an iris, etc.) of a user to obtain information of the detection part of the user. In addition, the photosensor array film receives an emission trigger signal, and enters a light emission state to emit light (e.g., infrared light). Optionally, the emission trigger signal and the detection trigger signal are applied alternately at a predetermined frequency. Take the photosensor array film formed by the photosensitive diode array as an example. In application, a bias voltage (including a forward bias voltage, a zero bias voltage or a negative bias voltage) can be applied by TFTs across the p-type/i-type/n-type photosensitive diodes, so the photosensor array film can emit infrared light.

Specifically, the forward bias voltage and one of the zero bias voltage and the negative bias voltage can be alternately applied across the p-type/i-type/n-type photosensitive diodes to serve as the emission trigger signal and the detection trigger signal. Take the photosensitive diode array with ten columns as an example. In a first period, a forward bias voltage is applied across the p-type/i-type/n-type photosensitive diodes in the ten columns, so the p-type/i-type/n-type photosensitive diodes in the ten columns all enter the light emission state to emit infrared light. In a second period, a zero bias voltage or a negative bias voltage is applied across the p-type/i-type/n-type photosensitive diodes in the ten columns, so the p-type/i-type/n-type photosensitive diodes in the ten columns all enter the light detection state to receive the infrared light reflected by, for example, an eyeball of a user and generate a corresponding image output. The first period and the second period are repeated alternately. In addition, the emission trigger signal and the detection trigger signal are applied alternately at a predetermined frequency. A total time of the first and second periods can be set according to application requirements. Optionally, the total time of the first and second periods can be set to the time sufficient to drive the photosensitive diode array and obtain a complete image output.

The aforesaid touch object operating method is to be implemented by the aforesaid electronic device, and is able to simultaneously obtain fingerprint information while receiving an operation instruction. The electronic device includes a display unit 2 and a sensor unit 3. The display unit 2 is provided with a fingerprint recognition area, and displays at least one touch object in the fingerprint recognition area. The sensor unit 3 is disposed below the display unit 2, and is operable to obtain fingerprint information of a finger appearing in the fingerprint recognition area. The touch object operating method includes receiving an operation instruction made on the touch object by a finger of a user and simultaneously obtaining fingerprint information of the finger of the user as input fingerprint information. The aforesaid solution can effectively simplify operation procedure to enhance user experience.

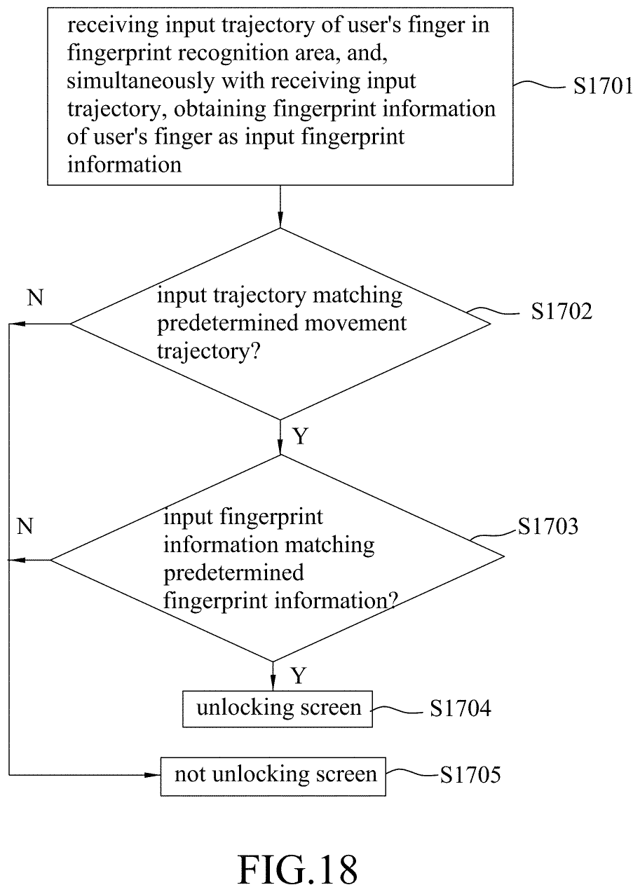

FIG. 18 illustrates an embodiment of a screen unlock method according to the disclosure. Referring to FIGS. 14 and 18, the screen unlock method is to be implemented by an electronic device identical to the aforesaid electronic device for implementing the aforesaid touch object operating method. The screen unlock method includes steps S1701-S1705.

In step S1701, the electronic device receives an input trajectory of a finger of a user in the fingerprint recognition area and, simultaneously with receiving the input trajectory, obtains fingerprint information of the finger of the user as input fingerprint information.

The input trajectory is the sliding trajectory of the user on the display unit 2, may be made by a single finger or multiple fingers of the user, and may be one of a line, a drawing of a pattern, a character, etc. As the input trajectory is being made, when the finger of the user is at a location outside the fingerprint recognition area, the fingerprint information of the user will not be obtained, and once the finger of the user slides into the fingerprint recognition area, the sensor unit 3 will obtain the fingerprint information of the user.

The act of receiving the input trajectory of the finger of the user in the fingerprint recognition area in step S1701 may include, by one of the sensor unit and the touch module 22 of the display unit 2, receiving the input trajectory of the finger of the user in the fingerprint recognition area, and generating information related to the input trajectory which is then stored in the electronic device. Both of the input trajectory and the fingerprint information may be obtained by the touch module 22. Alternatively, the input trajectory may be obtained by the touch module 22, while the fingerprint information may be obtained by the sensor unit 3.

In step S1702, the electronic device determines whether the input trajectory matches a predetermined movement trajectory. When it is determined that the input trajectory matches the predetermined movement trajectory, the flow proceeds to step S1703. Otherwise, the flow proceeds to step S1705.

In step S1703, the electronic device determines whether the input fingerprint information matches predetermined fingerprint information. When it is determined that the input fingerprint information matches the predetermined fingerprint information, the flow proceeds to step S1704. Otherwise, the flow proceeds to step S1705.

The predetermined fingerprint information may be preset and compared with the input fingerprint information in the same way as in the aforesaid touch object operating method.

In step S1704, the electronic device unlocks the screen thereof.

In step S1705, the electronic device does not unlock the screen thereof.

In this embodiment, the screen unlock method further includes a step of the electronic device outputting prompt information when it is determined that the input trajectory does not match the predetermined movement trajectory.

In some embodiments, the screen unlock method further includes aforesaid steps (S1501, S1502, S1601, S1602) of the touch object operating method.

In some embodiments, the screen unlock method is to be implemented by the electronic device, and is able to simultaneously obtain fingerprint information while receiving an input trajectory. The electronic device includes a display unit 2 and a sensor unit 3. The display unit 2 is provided with a fingerprint recognition area. The sensor unit 3 is disposed below the display unit 2, and is operable to obtain fingerprint information of a finger appearing in the fingerprint recognition area. The screen unlock method includes a step of receiving an input trajectory of a finger of a user in the fingerprint recognition area and, simultaneously with receiving the input trajectory, obtaining fingerprint information of the finger of the user as input fingerprint information, a step of determining whether the input fingerprint information matches predetermined fingerprint information when it is determined that the input trajectory matches a predetermined movement trajectory, and a step of unlocking a screen of the electronic device when it is determined that the input fingerprint information matches the predetermined fingerprint information. In this way, when the user intends to unlock the screen of the electronic device by sliding, the fingerprint information of the user will be obtained and identified simultaneously. This can enhance security of the screen unlocking. In addition, the user does not need to operate a specific button to have the fingerprint information obtained, which effectively enhances user experience.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that the disclosure is not limited to the disclosed embodiments but is intended to cover various arrangements included within the spirit and scope of the broadest interpretation so as to encompass all such modifications and equivalent arrangements.

What is claimed is:

1. A touch object operating method to be implemented by an electronic device that includes a display unit and a sensor unit, the display unit provided with a fingerprint recognition area, and displaying at least one touch object in the fingerprint recognition area, the sensor unit being operable to obtain fingerprint information of a finger appearing in the fingerprint recognition area, said touch object operating method comprising:
receiving an operation instruction made on the touch object by a finger of a user, and, simultaneously with receiving the operation instruction, obtaining fingerprint information of the finger of the user as input fingerprint information.

2. The touch object operating method of claim 1, further comprising:
based on the input fingerprint information and predetermined fingerprint information, deciding whether to execute an action that corresponds to the operation instruction made on the touch object.

3. The touch object operating method of claim 2, further comprising:
presetting operation configuration information that indicates a correspondence between the operation instruction and the predetermined fingerprint information.

4. The touch object operating method of claim 3, wherein the deciding whether to execute the action includes:
determining whether the input fingerprint information matches the predetermined fingerprint information, and executing the action that corresponds to the operation instruction made on the touch object when it is determined that the input fingerprint information matches the predetermined fingerprint information.

5. The touch object operating method of claim 3, wherein the presetting the operation configuration information includes:
after receiving a setting instruction made by the user, presenting the fingerprint recognition area in a visible manner;
obtaining fingerprint information of a finger of the user appearing in the fingerprint recognition area, and storing the fingerprint information thus obtained as the predetermined fingerprint information; and
displaying an operation instruction identification list, receiving a selection instruction made by the user to select an operation instruction identification from the operation instruction identification list, establishing the correspondence between an operation instruction that corresponds to the operation instruction identification thus selected and the predetermined fingerprint information, and storing the correspondence between the operation instruction and the predetermined fingerprint information.

6. The touch object operating method of claim 5, further comprising, prior to receiving the setting instruction made by the user:
receiving account information inputted by the user, and determining, based on the account information, whether to receive the setting instruction made by the user.

7. The touch object operating method of claim 2, further comprising:
when it is determined that the input fingerprint information does not match the predetermined fingerprint information, outputting prompt information that prompts the user to input fingerprint information again; and
when it is determined that the user have inputted fingerprint information for over a predetermined number of times and that the input fingerprint information inputted each time did not match the predetermined fingerprint information, performing one of notifying the user that the predetermined fingerprint information is not stored, prompting the user to set up the predetermined fingerprint information, and a combination thereof.

8. The touch object operating method of claim 1, the fingerprint recognition area including a plurality of fingerprint recognition sub-areas, the electronic device including a plurality of the sensor units that respectively correspond to the fingerprint recognition sub-areas, said touch object operating method further comprising one of:
receiving an activating instruction that is made by the user and that is related to one of the fingerprint recognition sub-areas, and activating one of the sensor units that corresponds to said one of the fingerprint recognition sub-areas to which the activating instruction is related; and
receiving a deactivating instruction that is made by the user and that is related to one of the fingerprint recognition sub-areas, and deactivating one of the sensor units that corresponds to said one of the fingerprint recognition sub-areas to which the deactivating instruction is related.

9. The touch object operating method of claim 1, wherein the receiving the operation instruction made on the touch object includes:
receiving the operation instruction, which is one of sliding, touching, pressing and clicking, made on the touch object, which is one of a text, a picture, a video, an audio file, a folder, a document and an application icon.

10. The touch object operating method of claim 1, wherein the receiving the operation instruction made on the touch object includes:
when the operation instruction is made by multiple fingers of the user, obtaining pieces of fingerprint information for the multiple fingers of the user at the same time.

11. The touch object operating method of claim 1, the display unit including a touch module, wherein the receiving the operation instruction made on the touch object includes:
by one of the sensor unit and the touch module, receiving a sliding trajectory made on the touch object by the finger of the user, generating sliding trajectory information, and storing the sliding trajectory information.

12. An electronic device comprising:
a display unit provided with a fingerprint recognition area, and configured to display at least one touch object in the fingerprint recognition area;
a sensor unit operable to obtain fingerprint information of a finger appearing in the fingerprint recognition area; and
a processor configured to receive an operation instruction made on the touch object by a finger of a user, and control said sensor unit to obtain fingerprint information of the finger of the user as input fingerprint information simultaneously with receiving the operation instruction.

13. The electronic device of claim 12, wherein said sensor unit and the fingerprint recognition area have the same dimensions.

14. The electronic device of claim 12, wherein:
the fingerprint recognition area includes a plurality of fingerprint recognition sub-areas;
said electronic device comprises a plurality of said sensor units that respectively correspond to the fingerprint recognition sub-areas, and further comprises a sensor unit control circuit;
when said processor receives an activating instruction that is made by the user and that is related to one of the fingerprint recognition sub-areas, said sensor unit control circuit activates one of said sensor units that corresponds to said one of the fingerprint recognition sub-areas to which the activating instruction is related; and
when said processor receives a deactivating instruction that is made by the user and that is related to one of the fingerprint recognition sub-areas, said sensor unit control circuit deactivates one of said sensor units that corresponds to said one of the fingerprint recognition sub-areas to which the deactivating instruction is related.

15. The electronic device of claim 12, wherein:
said display unit includes a plurality of display pixels;
said electronic device further comprises a cover glass, a touch screen, an optical glue and an optical element;
said touch screen is attached to a lower surface of said cover glass;
said optical glue is attached to a lower surface of said display unit and has a refractive index smaller than that of said cover glass; and
during the process in which said processor controls said sensor unit to, simultaneously with receiving the operation instruction, obtain the fingerprint information of the finger of the user,
said processor transmits a display driving signal to said display unit when said touch screen detects touch of the finger of the user,
at least one of said display pixels emits an output light when receiving the display driving signal from said processor, the output light being reflected by an upper surface of said cover glass to form an original reflected light,
said optical glue filters the original reflected light to remove a part of the original reflected light incident on a surface of said optical glue at an angle of incidence greater than a first critical angle to result in a first reflected light which is allowed to enter said optical element, the first critical angle being a smallest angle of incidence of the original reflected light on said surface of said optical glue that yields total internal reflection in said display unit,
said optical element filters the first reflected light to remove a part of the first reflected light incident on a surface of said optical element at an angle of incidence smaller than a second critical angle to result in a second reflected light, and makes the second reflected light enter said sensor unit at an angle of incidence smaller than a predetermined angle, the second critical angle being a smallest angle of incidence of the output light on said upper surface of said cover glass that yields total internal reflection in said cover glass, and
said sensor unit receives the second reflected light, generates the fingerprint information of the user based on the second reflected light, and provides the fingerprint information of the user to said processor as the input fingerprint information.

16. The electronic device of claim 15, wherein:
said processor drives, based on a predetermined timing signal, at least one of said display pixels of said display unit at a time to emit the output light, so as to form at least one light spot on said upper surface of said cover glass at a time and to scan the finger of the user to form the original reflected light.

17. The electronic device of claim 15, wherein:
said optical element is one of a light-shielding optical element, a phase-change optical element and a combination thereof;
said light-shielding optical element includes one of a pinhole array with regularly arranged pinholes and a pinhole array with irregularly arranged pinholes; and
said phase-change optical element includes one of a photonic crystal structure, a microlens array structure and a diffuse scattering structure, each of said photonic crystal structure and said microlens array structure having a refractive index that changes regularly, said diffuse scattering structure having a refractive index that changes irregularly.

18. The electronic device of claim 15, wherein said optical element is designed by using one of compressive sampling of coded apertures and digital holography.

19. The electronic device of claim 12, wherein:
said sensor unit is a photosensor array film that has a plurality of pixel sensing areas, and that includes a plurality of pixel sensing structures respectively disposed in the pixel sensing areas;
each of said pixel sensing structures includes a pixel film circuit that includes at least one thin film transistor, and a photosensor unit that includes one of a photosensitive diode and a photosensitive transistor.

20. The electronic device of claim 19, wherein:
said photosensor unit of each of said pixel sensing structures includes said photosensitive diode;
said photosensitive diode includes at least one stack structure each formed by a p-type semiconductor layer, an i-type semiconductor layer and an n-type semiconductor layer that are sequentially arranged from top to bottom; and
said i-type semiconductor layer of each of said at least one stack structure is one of a microcrystalline silicon structure and an amorphous germanium silicide structure.

21. The electronic device of claim 20, wherein:
for each of said at least one stack structure, one or each of said p-type semiconductor layer and said n-type semiconductor layer includes one of a multilayer structure having different crystal structures, a multilayer structure having different doping concentrations, and a multilayer structure having different crystal structures and different doping concentrations.

22. The electronic device of claim 19, wherein:
said photosensor unit of each of said pixel sensing structures includes said photosensitive transistor; and
said photosensitive transistor is a photosensitive thin film transistor that includes a gate, a source, a drain, an insulating layer and a light-absorbing semiconductor layer, and that has a structure that
said gate, said insulating layer and said source are sequentially arranged from bottom to top in a longitudinal direction,
said drain and said source are arranged in a transverse direction in a coplanar manner,
said insulating layer covers said gate so that said gate is in contact with neither said source nor said drain,
said source and said drain are spaced apart to form a photosensitive leakage current channel therebetween, and
said light-absorbing semiconductor layer is disposed in the photosensitive leakage current channel.

23. The electronic device of claim 19, wherein:
said photosensor unit of each of said pixel sensing structures includes said photosensitive transistor;
said photosensitive transistor is a photosensitive thin film transistor that includes a plurality of sources and a plurality of drains;
said sources are arranged in parallel, and are connected to each other;
said drains are arranged in parallel, and are connected to each other;
said sources and said drains are spaced apart to form photosensitive leakage current channels each between one of said sources and an adjacent one of said drains, where one of said drains is disposed in a first gap between any two adjacent ones of said sources, one of said sources is disposed in a second gap between any two adjacent ones of said drains, and said sources are interleaved with and spaced apart from said drains.

24. The electronic device of claim 23, wherein a distance between each of said sources and an adjacent one of said drains is less than an electron drift distance.

25. A screen unlock method to be implemented by an electronic device that includes a display unit and a sensor unit, the display unit provided with a fingerprint recognition area, the sensor unit being disposed below the fingerprint recognition area and being operable to obtain fingerprint information of a finger appearing in the fingerprint recognition area, said screen unlock method comprising:
receiving an input trajectory of a finger of a user in the fingerprint recognition area, and, simultaneously with receiving the input trajectory, obtaining fingerprint information of the finger of the user as input fingerprint information;
when it is determined that the input trajectory matches a predetermined movement trajectory, determining whether the input fingerprint information matches predetermined fingerprint information; and
when it is determined that the input fingerprint information matches the predetermined fingerprint information, unlocking a screen of the electronic device.

26. The screen unlock method of claim 25, the fingerprint recognition area including a plurality of fingerprint recognition sub-areas, the electronic device including a plurality of the sensor units that are respectively disposed below the fingerprint recognition sub-areas, said screen unlock method further comprising one of:
receiving an activating instruction that is made by the user and that is related to one of the fingerprint recognition sub-areas, and activating one of the sensor units that is disposed below said one of the fingerprint recognition sub-areas to which the activating instruction is related; and
receiving a deactivating instruction that is made by the user and that is related to one of the fingerprint recognition sub-areas, and deactivating one of the sensor units that is disposed below said one of the fingerprint recognition sub-areas to which the deactivating instruction is related.

27. An electronic device comprising:
a display unit provided with a fingerprint recognition area;
a sensor unit disposed below the fingerprint recognition area, and configured to receive an input trajectory of a finger of a user in the fingerprint recognition area, and to, simultaneously with receiving the input trajectory, obtain fingerprint information of the finger of the user as input fingerprint information; and
a processor configured to execute a computer program that causes said processor to
when it is determined that the input trajectory of the user matches a predetermined movement trajectory, determine whether the input fingerprint information matches predetermined fingerprint information, and
when it is determined that the input fingerprint information matches the predetermined fingerprint information, unlock a screen of the electronic device.

28. The electronic device of claim 27, wherein:
said display unit is a light emitting diode (LED) display that includes a plurality of display pixels;
said electronic device further comprises a cover glass, a touch screen, an optical glue and an optical element;
said cover glass, said touch screen, said LED display, said optical glue, said optical element and said sensor unit are sequentially arranged from top to bottom;
said touch screen is attached to a lower surface of said cover glass;
said optical glue is attached to a lower surface of said LED display, and has a refractive index smaller than that of said cover glass;
said processor transmits a display driving signal to said LED display when said touch screen detects touch of the finger of the user;
at least one of said display pixels emits an output light when receiving the display driving signal from said processor, the output light being reflected by an upper surface of said cover glass to form an original reflected light;
said optical glue filters the original reflected light to remove a part of the original reflected light incident on a surface of said optical glue at an angle of incidence greater than a first critical angle to result in a first reflected light which is allowed to enter said optical element, the first critical angle being a smallest angle of incidence of the original reflected light on said surface of said optical glue that yields total internal reflection in said LED display;
said optical element filters the first reflected light to remove a part of the first reflected light incident on a surface of said optical element at an angle of incidence smaller than a second critical angle to result in a second reflected light, and makes the second reflected light enter said sensor unit at an angle of incidence smaller than a predetermined angle, the second critical angle being a smallest angle of incidence of the output light on the upper surface of said cover glass that yields total internal reflection in said cover glass;
said sensor unit receives the second reflected light, generates the fingerprint information of the user based on the second reflected light, and provides the fingerprint information of the user to said processor as the input fingerprint information.

29. The electronic device of claim 28, wherein:
said optical element is one of a light-shielding optical element, a phase-change optical element and a combination thereof;
said light-shielding optical element includes one of a pinhole array with regularly arranged pinholes and a pinhole array with irregularly arranged pinholes; and
said phase-change optical element includes one of a photonic crystal structure, a microlens array structure and a diffuse scattering structure, each of said photonic crystal structure and said microlens array structure having a refractive index that changes regularly, said diffuse scattering structure having a refractive index that changes irregularly.

30. The electronic device of claim 28, wherein:
said processor drives, based on a predetermined timing signal, at least one of said display pixels of said LED display to emit the output light, so as to form at least one light spot on said upper surface of said cover glass, the at least one light spot scanning the finger of the user to form the original reflected light.

31. The electronic device of claim 27, wherein:
said sensor unit is a photosensor array film that has a plurality of pixel sensing areas, and that includes a plurality of pixel sensing structures respectively disposed in the pixel sensing areas;
each of said pixel sensing structures includes a pixel film circuit that includes at least one thin film transistor, and a photosensor unit that includes one of a photosensitive diode and a photosensitive transistor.

32. The electronic device of claim 31, wherein:
said photosensor unit of each of said pixel sensing structures includes said photosensitive diode;
said photosensitive diode includes a p-type semiconductor layer, an i-type semiconductor layer and an n-type semiconductor layer that are sequentially stacked from top to bottom; and
said i-type semiconductor layer is one of a microcrystalline silicon structure and an amorphous germanium silicide structure.

33. The electronic device of claim 31, wherein:
said photosensor unit of each of said pixel sensing structures includes said photosensitive transistor; and
said photosensitive transistor is a photosensitive thin film transistor that includes a gate, a source, a drain, an insulating layer and a light-absorbing semiconductor layer, and that has a structure that
said gate, said insulating layer and said source are sequentially arranged from bottom to top in a longitudinal direction,
said drain and said source are arranged in a transverse direction in a coplanar manner,
said insulating layer covers said gate so that said gate is in contact with neither said source nor said drain,
said source and said drain are spaced apart to form a photosensitive leakage current channel therebetween, and
said light-absorbing semiconductor layer is disposed in the photosensitive leakage current channel.
